(19) United States
(12) Patent Application Publication
(10) Pub. No.: US 2019/0073456 A1
(43) Pub. Date: Mar. 7, 2019

(54) METHOD AND SYSTEM FOR CONTROLLING ACCESS TO ELECTRONIC DEVICE

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: GUANG-DONG HE, Zhengzhou (CN); CHAO-MAO LEE, New Taipei (TW); CHIH-HE CHEN, New Taipei (TW); JIN-LUN YU, Zhengzhou (CN); HONG-WEI ZHANG, Zhengzhou (CN); DONG LI, Zhengzhou (CN); MENG-JU LI, Zhengzhou (CN); DIAN-YING JIA, Zhengzhou (CN); WEI-QIANG HU, Zhengzhou (CN); GAO-YONG MAN, Zhengzhou (CN); FU-CHUN ZHANG, Zhengzhou (CN)

(21) Appl. No.: 15/791,254

(22) Filed: Oct. 23, 2017

(30) Foreign Application Priority Data
Sep. 1, 2017 (CN) 201710783875.7

(51) Int. Cl. G06F 21/31; G06F 17/30; G06K 7/14; G06K 19/06

(52) U.S. Cl. CPC G06F 21/31; G06K 19/06037; G06K 7/1417; G06F 17/30424

(57) ABSTRACT

A system and method for restricting and controlling access to electronic devices, the system includes a database of workers, a fool-proofing unit, and a controlling unit. The fool-proofing unit includes an information input module collecting information as to an electronic device and identity and extent of authority of a worker requesting to use such electronic device. A query module to search the database is also included, the query module can determine whether the worker has the authority to sign in to use a certain electronic device. The controlling unit can power on the electronic device when a given worker with necessary authority signs in to use the electronic device. The method is also disclosed.

### FIELD

The subject matter herein generally relates to workplace safety, and pertains particularly to a method for controlling access to devices, and a system for controlling access to devices.

### BACKGROUND

With development of modern industry, industrial manufacturing procedures are getting increasingly refined and precise, meanwhile manufacturing equipments are getting more diverse. Generally, workers need to be trained before they are authorized to operate such equipments, otherwise accidents may happen. Therefore, a method for controlling access to electronic devices, and a system for controlling access to electronic devices to prevent untrained workers from getting access to the electronic devices can be beneficial.

### BRIEF DESCRIPTION OF THE DRAWINGS

Implementations of the present technology will now be described, by way of example only, with reference to the attached figures.

FIG. 1 is a block diagram of an exemplary embodiment of a system for controlling access to an electronic device.

FIG. 2 is a block diagram of an exemplary embodiment of a method for controlling access to an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

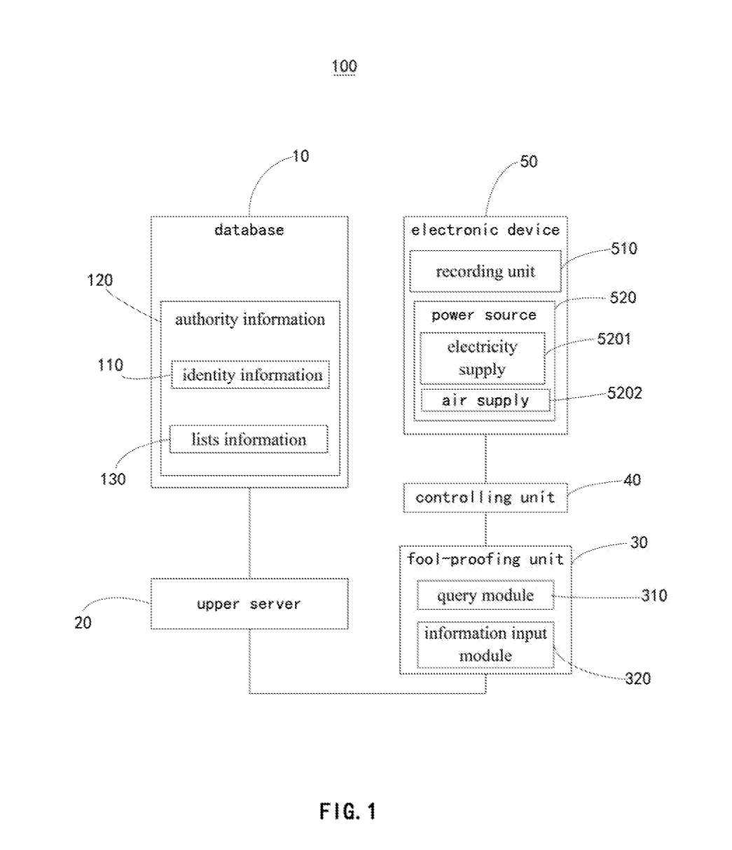

FIG. 1 illustrate a system 100 for controlling access to an electronic device 50. The system 100 can include a database 10, a fool-proofing unit 30, and a controlling unit 40.

The database 10 has authority information 120 of workers stored therein. The authority information 120 of workers can include information regarding the identity of workers (identity information 110) and information regarding the electronic devices accessible by each worker (lists information 130).

The fool-proofing unit 30 can include an information input module 320 and a query module 310.

The information input module 320 is configured to collect information of an electronic device 50 and identity information 110 of a worker who requests signing in to use an electronic device 50.

The query module 310 is configured to search the database 10 based on the information of the electronic device 50 and the identity information 110 of the worker who issues a request, and then determines whether the worker has the authority required for operating the electronic device 50.

Specifically, the query module 310 communicates with the information input module 320. When a worker issues a request for signing in for the electronic device 50, the information input module 320 collects information of the electronic device 50 and identity information 110 of the worker, and sends the information to the query module 310. The query module 310 searches the database 10 based on the information of the electronic device 50 and the identity information 110 of the worker to determine whether the device 50 is one of the electronic devices listed in a lists information 130.

The controlling unit 40 is configured to power on a power source 520 of the electronic device 50 when the worker has the authority to sign in for the electronic device 50. The power source 520 can include electricity supply 5201 and air supply 5202. For example, if the device 50 is one of the electronic devices listed in a lists information 130, the device 50 can be operated by the worker who issues a request for signing in for the electronic device 50, and the controlling unit 40 can power on the electronic device 50.

The system 100 for controlling access to electronic devices can further include an upper server 20. The fool-proofing unit 30 and the controlling unit 40 can be located in the electronic device 50. The database 10 communicates with the upper server 20, and the fool-proofing unit 30 communicates with the upper server 20. For example, the fool-proofing unit 30 can communicate with the upper server 20 through a network and search the database 10 through the upper server 20.

In at least one exemplary embodiment, the system 100 for controlling access to electronic devices can further include a plurality of identity authentication terminals (not shown) distributed to workers. The information input module 320 is configured to read the identity authentication terminals to collect identity information 110 of a worker. The identity authentication terminals can be an office identification card. In an exemplary embodiment, when an identity authentication terminal is placed on an electronic device 50, the electronic device 50 can be powered on, and when the identity authentication terminal is taken away from the accessible electronic device 50, the electronic device 50 is powered off.

The controlling unit 40 can be a fool-proofing box connected between the fool-proofing unit 30 and the power source 520 of an electronic device 50. The fool-proofing box controls the power source 520 to turn on when a worker has the authority to sign in for the electronic device 50.

In at least one exemplary embodiment, the system 100 for controlling access to electronic devices can further include a recording unit 510. The recording unit 510 is configured to collect and store information of workpieces loaded on or processed by the electronic device 50. The recording unit 510 can communicate with the fool-proofing unit 30.

The recording unit 510 collects information of a workpiece after the electronic device 50 is powered on and the workpiece is loaded on the electronic device 50. The fool-proofing unit 30 generates a process record based on the information of the electronic device 50, the identity information of the worker, and the information of the workpiece. The process record can be stored to track manufacturing procedures of a workpiece, which can be processed by the electronic device 50.

The database 10 can be further configured to store information of the workpieces in advance. The system 100 further includes an identifier attached to each of the workpieces. The identifier is associated with the information of a workpiece. The recording unit can collect information of a workpiece by reading the identifiers. For example, the identifier can be one- or two-dimensional barcode, and the recording unit 510 includes a barcode scanner to read such barcodes.

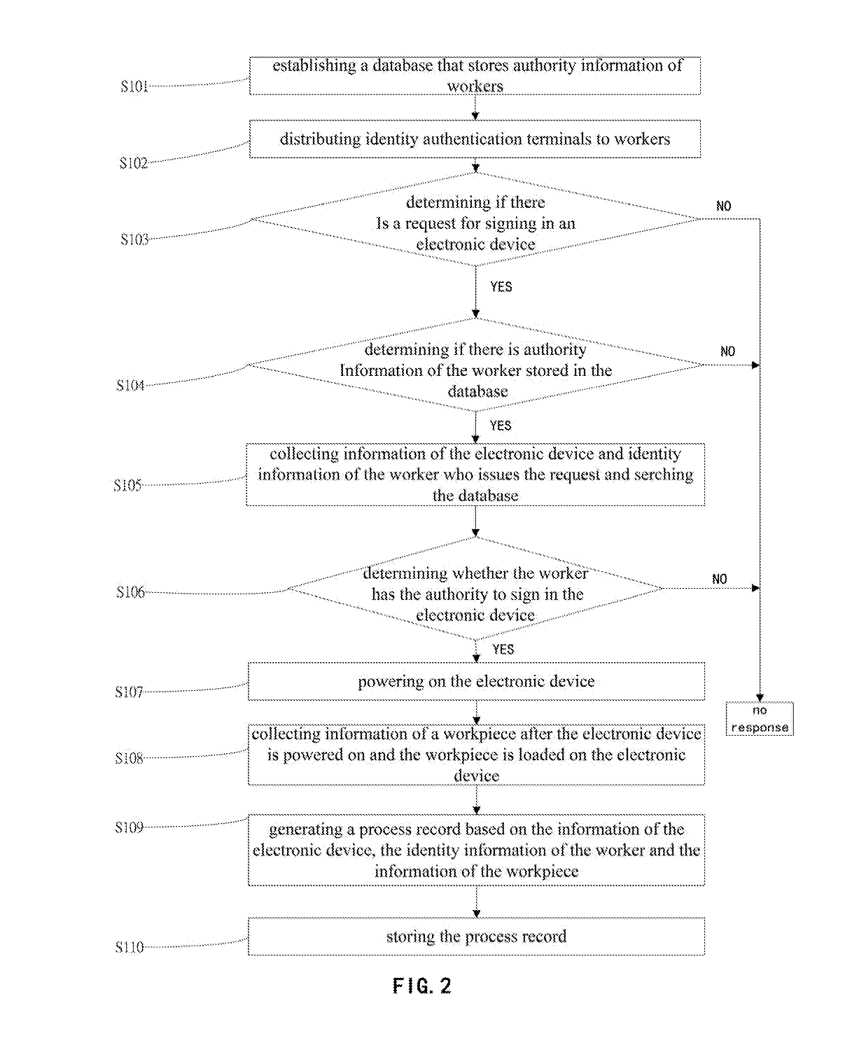

FIG. 2 illustrate a method for controlling access to an electronic device. The method can include steps as follows.

S101: establishing a database that stores authority information of workers. The authority information of workers can include identity information of the workers and lists information of accessible electronic devices corresponding to each worker.

S103: determining if there is a request for signing in an electronic device. When there is a request for signing in an electronic device, the method proceeds to step S105, otherwise no response is made by the electronic device.

S105: collecting information of the electronic device and identity information of the worker who issues the request, and searching the database based on the information of the electronic device and the identity information of the worker when the request for signing in the electronic device is made.

S106: determining whether the worker has the authority to sign in the electronic device. When the worker has the authority to sign in the electronic device, step S107 is proceeded, otherwise no response is made by the electronic device.

S107: powering on the electronic device.

In at least one exemplary embodiment, there can be a step S102 between the steps S101 and S103.

S102: distributing identity authentication terminals to workers. Determining if there is a request for signing in an electronic device is accomplished by detecting if there is an identity authentication terminal read by the electronic device. Collecting identity information of a worker can be accomplished by reading the worker's identity authentication terminal.

In at least one exemplary embodiment, there can be a step S104 between the steps S103 and S105.

S104: determining if there is authority information of the worker stored in the database. If there is authority information of the worker stored in the database, then proceed to step S105, otherwise steps after step S104 are suspended, so that unauthorized people (strangers or visitors) can be prevented from operating the electronic device by mistake.

In at least one exemplary embodiment, the method for controlling access to electronic devices can further include steps as follows.

S108: collecting information of a workpiece after the electronic device is powered on and the workpiece is loaded on the electronic device.

S109: generating a process record based on the information of the electronic device, the identity information of the worker and the information of the workpiece.

S110: storing the process record.

The process record can be stored in the database.

The step S108 can be accomplished by:

storing information of the workpieces in the database in advance;

attaching an identifier to each of the workpieces, wherein the identifier is associated with the information of a corresponding workpiece;

collecting information of a workpiece can be accomplished by reading the identifier of the workpiece. The identifier can be a one-dimensional code or a two-dimensional code.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A method for controlling access to electronic devices comprising:
establishing a database that stores authority information of workers;
determining if there is a request for signing in an electronic device;
collecting information of the electronic device and identity information of the worker who issues the request when the request for signing in the electronic device is made;
searching the database based on the information of the electronic device and the identity information of the worker;
determining whether the worker has the authority to sign in the electronic device; and
powering on the electronic device when the worker has the authority to sign in the electronic device.

2. The method for controlling access to electronic devices of claim 1, wherein the method further comprises:
distributing identity authentication terminals to the workers.

3. The method for controlling access to electronic devices of claim 2, wherein determining if there is a request for signing in an electronic device is accomplished by detecting if there is an identity authentication terminal read by the electronic device.

4. The method for controlling access to electronic devices of claim 2, wherein collecting identity information of the worker is accomplished by reading an identity authentication terminal.

5. The method for controlling access to electronic devices of claim 1, wherein determining whether the worker has the authority to sign in the electronic device comprises:
determining if there is authority information of the worker stored in the database; and
determining whether the worker has the authority to sign in the electronic device according to the authority information of the worker when there is authority information of the worker stored in the database.

6. The method for controlling access to electronic devices of claim 1, wherein the method further comprises:
collecting information of a workpiece after the electronic device is powered on and the workpiece is loaded on the electronic device;
generating a process record based on the information of the electronic device, the identity information of the worker and the information of the workpiece; and
storing the process record.

7. The method for controlling access to electronic devices of claim 6, wherein the process record is stored in the database.

8. The method for controlling access to electronic devices of claim 6, wherein the method further comprises:
storing information of workpieces in the database in advance;
attaching an identifier to each of the workpieces, wherein the identifier is associated with the information of a corresponding workpiece;
wherein collecting information of a workpiece is accomplished by reading the identifier of the workpiece.

9. The method for controlling access to electronic devices of claim 8, wherein the identifier is a one-dimensional code or a two-dimensional code.

10. A system for controlling access to electronic devices comprising:
a database having authority information of workers stored in;
a fool-proofing unit comprising:
an information input module configured to collect information of an electronic device and identity information of a worker who issues a request for signing in the electronic device; and
a query module configured to search the database based on the information of the electronic device and the identity information of the worker and determine whether the worker has the authority to sign in the electronic device; and
a controlling unit configured to power on the electronic device when the worker has the authority to sign in the electronic device.

11. The system for controlling access to electronic devices of claim 10, wherein the authority information comprises identity information of the workers and lists of accessible electronic devices corresponding to each of the workers.

12. The system for controlling access to electronic devices of claim 10, wherein the system for controlling access to electronic devices further comprises an upper server, the database communicates with the upper server, and the fool-proofing unit communicates with the upper server.

13. The system for controlling access to electronic devices of claim 12, wherein the fool-proofing unit and the controlling unit are located in a corresponding electronic device.

14. The system for controlling access to electronic devices of claim 10, wherein the system for controlling access to electronic devices further comprises a plurality of identity authentication terminals distributed to the workers, the information input module is configured to read the identity authentication terminals.

15. The system for controlling access to electronic devices of claim 10, wherein the controlling unit is a fool-proofing box connected between the fool-proofing unit and the power source of an electronic device, the fool-proofing box controls the power source to open when a worker has the authority to sign in the electronic device.

16. The system for controlling access to electronic devices of claim 12, wherein the system for controlling access to electronic devices further comprises an recording unit configured to collect and store information of workpieces loaded on the electronic devices.

17. The system for controlling access to electronic devices of claim 16, wherein the recording unit communicates with the fool-proofing unit;
the recording unit collects information of a workpiece after the electronic device is powered on and the workpiece is loaded on the electronic device; the fool-proofing unit generates a process record based on the information of the electronic device, the identity information of the worker and the information of the workpiece.

18. The system for controlling access to electronic devices of claim 17, wherein the database is further configured to store information of workpieces in advance; the system for controlling access to electronic devices further comprises identifiers respectively attached to each of the workpieces, the identifier is associated with the information of a corresponding workpiece;
the recording unit collects information of the workpieces by reading the identifiers.

19. The system for controlling access to electronic devices of claim 18, wherein the identifiers are one-dimensional code bars, and the recording unit comprises a barcode scanner.

20. The system for controlling access to electronic devices of claim 18, wherein the identifiers are two-dimensional code bars, and the recording unit comprises a scanner to read the two-dimensional code bars.
